(19) United States
(12) Patent Application Publication
(10) Pub. No.: US 2003/0046798 A1
(43) Pub. Date: Mar. 13, 2003

(54) Biodegradable funerary urn

(76) Inventors: Julia Valles Camps, Sispony (AD); Xavier Miquel Gutierrez, La Massana (AD)

Correspondence Address: James C. Wray, Suite 300, 1493 Chain Bridge Road, McLean, VA, 22101, US

(21) Appl. No.: 09/948,601

(22) Filed: Sep. 10, 2001

(51) Int. Cl. A61G 17/00

(52) U.S. Cl. 27/1

(57) ABSTRACT

The urn, structured on the basis of a body, a cap and optionally an over-cap, of any size and shape and with any conventional lock system, focuses its characteristics on the fact that the constituent material of its different pieces is complete and quickly biodegradable. In this respect it has been foreseen that the urn is made of gelatin, which is obtained from the partial hydrolysis, acid or alkaline one, from the collagen, or optionally by other materials with the same characteristic of biodegradability, making it up by pressing and injection in absence of contact adhesives and artificial varnishes.

### BACKGROUND OF THE INVENTION

The present invention is referred to as a funerary urn, that is to say, a container which contains the ashes that constitute the residues of a corpse's cremation. This urn has been conceived and structured in order to obtain a biodegradable character, so that it does not have a negative effect on the environment when this one is finally thrown away. The invention is focused on the field of the funerary services.

As a result of the high costs of burials, especially in big urban centers, that are derived from the lack of space and the resulting increase of the price of the grounds, needs exist for a progressive reduction in the number of burials in favor of the cremations, and at the same time the cremations conclude, in most of the cases, with the handing over of the ashes to the deceased's relatives, for the custody by the deceased's family.

So, once the cremation phase off, the ashes are put in an urn that is handed over to the relatives of the deceased, in most cases by their own request. But, is a problem for them in the long run, owing to the fact that they would really prefer to have given the deceased a definitive fate, instead of choosing the option of the urn due to economical reasons.

In practice and after a more or less short period of time, in which the urn is kept at home, a search is made for a definitive fate, and the spreading of the ashes constitutes one of the most usual options, for example in the sea. That solution has the disadvantage of the impossibility of disposing in a physical place that represents the deceased's memory, that is to say a place that is able to be visited subsequently on special days. In addition the urn, once it is empty, turns into an unusable one, representing an object the relatives have to get rid of, with the option of throwing it away, so that it ends up in a dump, which does not seem to be very ethical, owing to the fact that it is the receptacle that has contained the mortal remains of a loved being.

As a consequence, the urns are also thrown in the sea, when the sea is the spreading point of the ashes, or left in the mountains, which is an unacceptable solution from an ecological point of view because the urn for the most part is made of bronze, iron or other kind of metal. That constitutes a residue that is very difficult for the environment to assimilate, be it land or aquatic, with the existing risk that certain materials, such as the heavy metals, cause serious damage to the environment.

Although there are urns made of wood, that represent a minimum part of the market, that are biodegradable by their own nature, these urns are usually structured on the basis of several pieces glued and covered by varnish, so that such contact adhesives and varnishes are high pollutants.

### SUMMARY OF THE INVENTION

The funerary urn that is proposed by the invention solves, in a fully satisfactory way, the problems previously stated, in all and every different aspect. Its own conception provides it with a definitive fate, for example its burial, which at the same time provides a location which the family can visit, thus avoiding the problems of leaving the urns anywhere in the sea or in the mountains.

More specifically, the urn of the present invention focuses its characteristics on a structure of a material which is completely biodegradable, specifically on the basis of gelatin.

As it is known, the gelatin is a purified protein, which is obtained from the partial acid or alkaline hydrolysis of collagen, the main constituent protein of the connective tissues of animal origin, representing a solid product of a color between weak yellow and clear amber, almost insipid, which is usually showed in a translucent engraving shape, granules or powder and that is practically insoluble in normal organic solvents.

So, the urn made of gelatin turns out completely ecologically sound insofar as it is totally biodegradable, consequently allowing its burial, with the ashes of the deceased, anywhere appropriate chosen by the relatives or friends of the deceased. That location may be in the mountains, in a public place or in a private one, or in grounds specifically assigned for that purpose. Due to the easily transported urns, the burial can be far from the city centers, where the cost will be unquestionably much more reduced than the corresponding cost of a grave or a perpetual deep recess in a wall used as a tomb, yet with similar burial services as regular burials or entombment.

Furthermore, the urn may be of any size and capacity, similar to conventional urns, deriving its advantages basically from the fact that it is quickly degradable and totally harmless to the environment.

Optionally, the gelatin may be substituted by other products of similar biodegradability characteristics, using pressing systems and injection molding that conform to the urn the formal appropriate stability in the absence of contact adhesives and artificial varnishes.

Using gelatin as well as using other products of similar biodegradability characteristics, the urn breaks up quickly, integrating into the ground as inorganic matter, which will be subsequently changed into organic matter by plants, closing the cycle of the natural matter, and improving the soil consistency of the ground.

The urn structured in this manner does not prevent the urn from remaining in the deceased relatives' homes indefinitely, nor does it reduce its possible future burial. Apart from being buried in natural plots of land, it can be carried out in a private garden or in any other proper space.

### BRIEF DESCRIPTION OF THE DRAWING

In order to complement the description that is being carried out and with the purpose of helping to a better understanding of the invention's characteristics, according to an example of a practical fulfillment of it, it is enclosed as a member part of such description, a plane view in which with an illustrative character and non restrictive one and in its unique figure, it has been represented in a schematic way, in side elevation and in a quarterly way, a funerary urn carried out according to the purpose of the current invention.

### DETAILED DESCRIPTION OF THE PREFERRED EMBODIMENTS

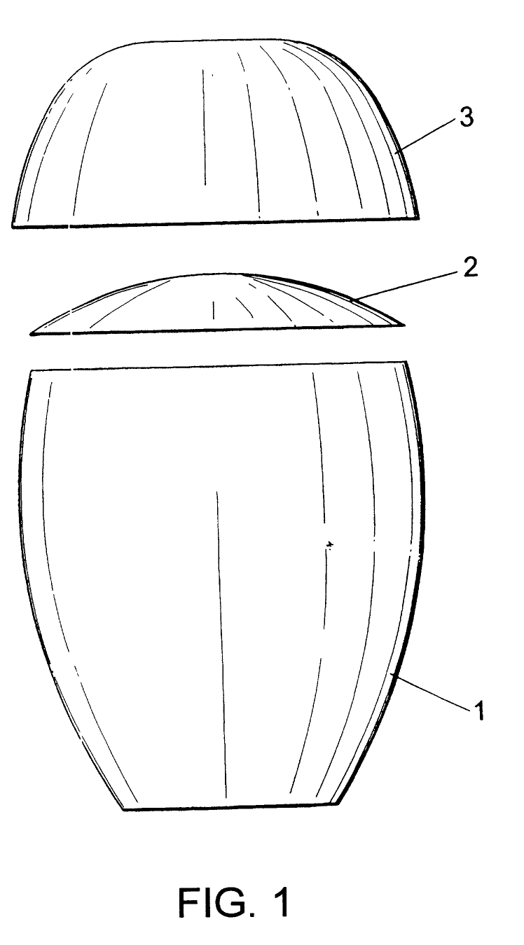

As seen in FIG. 1, it can be noted how the funerary urn that is formed, just as any conventional urn, is constituted by means of a body 1, of proper shape and capacity, that is complemented as usual by a cap 2 and an over-cap 3. The cap is fixed to the body 1 by any conventional means, such as by connection by pressing, to which effect the mouthpiece of the over-cap 3 will have to be swiftly over dimensioned with regard to the mouthpiece of the body 1.

The invention is focused on the fact that the different elements 1, 2 and 3 of the urn are obtained on the basis of a biodegradable material, and it has been foreseen as a preferential solution on the matter under discussion, the use of a gelatin that, such as it is, it includes a content in proteins that is between 84% and 90% mineral salts that may at the same time have between 1%-2% water in the rest of its formulation.

The gelatin contains neither preservative agents nor other additives. It is exempted from cholesterol and fat matter.

Specifically the chosen preferred gelatin composition (“aminograma”) is as follows:

Alanine 8.13%

Aspartic acid 5.15%

Threonine 1.80%

Serine 3.22%

Glutamic acid 7.50%

Proline 11.98%

Glycine 23.65%

Cystine 0.50%

Valine 2.02%

Tryptophan 0.27%

Methionine 0.78%

Isoleucine 0.71%

Tyrosine 1.19%

Leucine 1.36%

Phenytalanine 0.92%

Lysine 2.96%

Histidine 0.66%

Arginine 8.31%

Hydroxyproline 12.59%

We claim:

1. Funerary urn, that being structured on the basis of a body with a proper capacity to the ashes that has to lodge inside it, with any shape, assisted by the corresponding cap and by an over-cap if necessary, is characterized by the fact that all and every one of the different member elements of it are obtained exclusively on the basis of biodegradable material.

2. Funerary urn, according to claim 1, is characterized because its constituent biodegradable material is made of Gelatin, which is obtained from the partial hydrolysis, whatever acid or alkaline one, of the collagen.

3. Funerary urn, according to claim 1, is characterized because its constituent biodegradable material is made of gelatin an other materials with the same characteristic of biodegradability, in absence of contact adhesives and artificial varnishes, having been foreseen to that purpose the fact that the structure of the member pieces of the urn is carried out following a classical pressing system and injection one.
